(19) United States
(12) Patent Application Publication
(10) Pub. No.: US 2025/0291127 A1
(43) Pub. Date: Sep. 18, 2025

(54) OPTICAL INTERCONNECTS AND RELATED METHODS

(71) Applicant: Intel Corporation, Santa Clara, CA (US)

(72) Inventor: Frank F. Wu, San Jose, CA (US)

(21) Appl. No.: 18/606,731

(22) Filed: Mar. 15, 2024

(51) Int. Cl. G02B 6/38; G02B 6/36

(52) U.S. Cl. CPC G02B 6/3885; G02B 6/3664; G02B 6/3818

(57) ABSTRACT

Optical interconnects and related methods are disclosed. An example apparatus described herein includes an optical component carrier including a first tapered surface, a second tapered surface, and an optical component, a waveguide carrier including a third tapered surface engaged with the first tapered surface, and a fourth tapered surface engaged with the second tapered surface, and a waveguide including a second end aligned with the first end.

### FIELD OF THE DISCLOSURE

This disclosure relates generally to fiber optics and, more particularly, to optical interconnects and related methods.

### BACKGROUND

Optical interconnects facilitate the transmission of signals from one portion of an electronic device to another electronic device. Optical interconnects use waveguides, such as fiber optics, to channel light from a light emitter to a light detector. optical interconnects have comparatively lower latency, lower power loss over distance, and power consumption than electrical interconnects. The use of optical interconnects enables power-efficient and low-latency communications.

### BRIEF DESCRIPTION OF THE DRAWINGS

FIG. 1 is a perspective view of an example system including an example interconnect between an example optical component carrier and an example waveguide carrier implemented in accordance with teachings of this disclosure.

FIG. 2 is a top schematic view of the interconnect of FIG. 1.

FIG. 3 is a top schematic view of another example interconnect implemented in accordance with teachings of this disclosure.

FIG. 4 is a top schematic view of another example interconnect implemented in accordance with teachings of this disclosure.

FIG. 5 is a top schematic view of another example interconnect implemented in accordance with teachings of this disclosure.

FIG. 6 is a flowchart representative of example operations that can be used to assemble one or more of the interfaces of the FIGS. 1-5.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

As used herein, the orientation of features is described with reference to a lateral axis, a vertical axis, and a longitudinal axis of an optical interconnect including an array of waveguides. As used herein, the longitudinal axis is parallel to a major axis of the waveguides of the optical interconnect (e.g., the direction along which the light signal flows within the waveguide carrier, the major axis of the cylinder defined by the waveguide carrier, etc.). As used herein, the lateral axis is perpendicular to the longitudinal axis and is disposed in the plane in which the waveguides of the waveguide array are disposed. As used herein, the vertical axis is perpendicular to the longitudinal and lateral axes. In general, the attached figures are annotated with a set of axes including the longitudinal axis X, the lateral axis Y, and the vertical axis Z.

Optical compute interconnects (OCI) and co-packaged optics (CPO) are being explored for use in artificial intelligence systems, supercomputers, and data centers. OCIs and CPOs offer comparatively greater bandwidth and speed offered by optical interconnects when compared to electrical interconnects. Additionally, optical connections use comparatively less power than electrical connections, are suitable for use long-distance connections (e.g., over 100 meters, over 1000 meters, etc.), and are not susceptible to electromagnetic interference from other electrical components.

The optical connections of OCI systems and CPO systems enable such systems to communicate with outside systems (e.g., other OCI systems, other CPO systems, etc.). Many prior OCI systems include connectors that have a plurality of waveguides, which enables multi-wavelength and/or multi-channel communication. In some examples, these prior OCI systems include fiber ribbons that include multiple optical fibers closely packed together in a single plane. As used herein, the term “waveguide” refers to any structure that guides a light signal from one location to another. One type of waveguide is optical fibers, which are flexible transparent fibers that transmit light via internal reflection. Some optical fibers are coated with claddings and/or jackets to facilitate the reflection of light within the core of the fiber and to protect the fiber from damage. As used herein, the terms “fiber” and “optical fiber” are used interchangeably. As used herein, the end of a waveguide is interchangeably referred to as a “facet” and an “end.”

Optical interconnects can be coupled to a light emitter (e.g., a laser, etc.) and/or a light detector of a silicon photonic integrated circuit (PIC). To enable the transmission of signals from a PIC via an optical interconnect, the ends of the waveguides of the optical interconnect must be precisely aligned with the waveguides of corresponding emitters and/or detectors (e.g., emitter media, etc.) of the PIC. For example, misalignments between the ends of the waveguides of the optical interconnect and the ends of the emitters and/or detectors of the PIC of greater than one micron (μm) can significantly degrade signal integrity. Prior PICs include a plurality of grooves that receive the optical fibers of a ribbon cable. Some such prior PICs include an epoxy coupling (e.g., an epoxy attachment, etc.) between the optical fibers and the V-grooves to facilitate the vertical and lateral alignment of the optical components of the OCI. Some such prior interconnects include a glass lid, which is coupled, via epoxy, to the optical fibers and the grooves. The use of epoxy to couple the optical fibers to the V-grooves and the glass lid to the PIC can cause the flow of epoxy into the space between the waveguide ends (e.g., facets, fiber facets, etc.) and the PIC emitter ends (e.g., facets, etc.). In optical interconnects that include air gaps, the unexpected presence of epoxy particles between the PIC and the waveguide end can cause significant signal losses.

Prior OCI's optical interconnects pose additional challenges. The use of fiber ribbons (e.g., arrays of individual fibers, etc.) can make maintaining consistent facet lengths labor-intensive and/or costly. Differences in facet lengths among the fibers of a fiber ribbon of greater than 5 microns can result in signal loss, a lack of uniformity in performance among the fibers of the fiber ribbon, and a degradation of signal quality and reliability. Another challenge posed by prior optical interconnects is the packaging of optical isolators (e.g., optical diodes, etc.). Optical isolators can be difficult to package within an optical interconnect that includes a plurality of discrete optical fibers attached to V-grooves. Additionally, the simultaneous and precise alignment of multiple optical fibers within the grooves can be challenging given the small margin for misalignment. Additionally, some prior optical interconnects include V-grooves, which receive fibers during assembly. The grooves of such prior optical interconnects can become contaminated with material from the assembly of the interconnect (e.g., adhesive, epoxy, etc.) or foreign debris particles during assembly (e.g., dust, etc.). In some examples, the contamination can prevent the seating of the fibers in grooves and/or cause misalignment. In some examples, such contamination can cause significant signal losses (e.g., partial signal losses, full signal loss, etc.).

Examples disclosed herein overcome the above-noted challenges. Some such examples include waveguide carriers with tapered surfaces to facilitate the alignment of optical fibers and the optical components of the PICs. Some example waveguide carriers include a plurality of waveguides disposed in parallel. Some such example waveguide carriers include tapered surfaces. Some example PICs include optical component carriers with tapered surfaces that are complimentary with the tapered surfaces of the waveguide carrier. In some examples disclosed herein, the tapered surfaces of the optical component carrier interface with the waveguide carriers to facilitate lateral alignment of the ends of the waveguide carrier and the optical component carrier. Some examples disclosed herein include a stop surface to facilitate the longitudinal alignment of the waveguide ends and the optical component ends. Some examples disclosed herein include a glass plate coupled to the waveguide carrier and/or the optical component carrier to facilitate the vertical alignment of the waveguide ends and the optical component ends. The example waveguide carriers and optical component carriers described herein are less cost and labor-intensive to manufacture than a fiber ribbon including a same number of fibers.

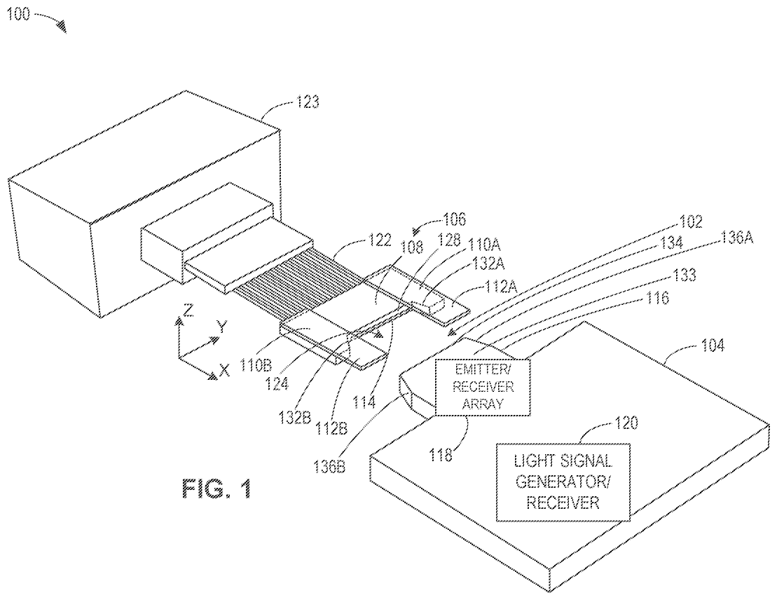

FIG. 1 is a partially exploded perspective view of an example system 100 including an example interconnect 102 between an example photonic integrated circuit 104 and an example waveguide carrier 106 implemented in accordance with teachings of this disclosure. In the illustrated example of FIG. 1, the waveguide carrier 106 includes an example body 108, an example first wing 110A, an example second wing 110B, an example first plate 112A, an example second plate 112B, and an example waveguide array 114. In the illustrated example of FIG. 1, the PIC 104 includes an example optical component carrier 116. The optical component carrier 116 includes an example component array 118, and an example light signal generator/receiver 120. In the illustrated example of FIG. 1, the waveguide carrier 106 is coupled to an example ribbon 122, which extends from an example connector 123. In the illustrated example of FIG. 1, portions of the waveguide carrier 106 visually obstructed by the plates 112A, 112B are depicted via dashed lines. It should be appreciated that dashed lines are included throughout the attached figures for visual clarity only.

The PIC 104 of this example is an integrated circuit (e.g., a chip, etc.) that generates and/or processes light signals (e.g., photons, etc.). In the illustrated example of FIG. 1, the PIC 104 includes the light signal generator/receiver 120, which generates and/or receives light signals, and the component array 118. In some examples, the component array 118 is an emitter array (e.g., includes a plurality of emitters that output light signals generated by the light signal generator/receiver 120, etc.), a detector array (e.g., includes a plurality of detectors that receive light transmitted via the waveguide carrier 106, etc.), and/or a hybrid array (e.g., includes both detectors and emitters, etc.). In some examples, the component array 118 can include an array of waveguides that direct light to the components (e.g., the detectors, emitters, etc.). In some examples, the component array 118 can include a PIC waveguide array.

In some examples, the PIC 104 includes one or more additional waveguides and/or components for the detecting, processing, and/or generating of light signals. For example, the PIC 104 can include one or more interfaces (e.g., wired interfaces, wireless interfaces, etc.) to an electronic integrated circuit (EIC). Additionally or alternatively, the PIC 104 can include one or more structures to receive data, one or more transducers, one or more modulators, one or more memories, one or more other interfaces, and/or other components. In some such examples, the PIC 104 receives an input from an EIC, which the light signal generator/receiver 120 processes and uses to generate one or more light signals to output via the component array 118. The light signals are modulated to convey data corresponding to the input. In some examples, the PIC 104 is coupled to a baseboard and/or a component of one or more larger compute system(s) (e.g., a server, a computer, a data center, an artificial intelligence (AI) data center, etc.). In some examples, the PIC 104 is a silicon photonic interface circuit (e.g., the PIC 104 includes silicon, etc.) that may include many integrated optical components.

The waveguide carrier 106, also referred to herein as a fiber array block (FAB), a fiber waveguide carrier, and/or a fiber array unit (FAU), is a structure that contains the waveguide array 114. In the illustrated example of FIG. 1, the waveguide carrier 106 includes the body 108, the wings 110A, 110B, and the plates 112A, 112B. In the illustrated example, the body 108 and the wings 110A, 110B are integral components and the plates 112A, 112B are discrete components coupled thereto. In other examples, the body 108, the wings 110A, 110B, and the plates 112A, 112B are integral (e.g., manufactured from a singular blank, additively manufactured, etc.). In other examples, the components of the waveguide carrier 106 are coupled together via one or more chemical fasteners (e.g., adhesives, epoxies, etc.), one or more mechanical fasteners, one or more interference fits, and/or one or more welds (e.g., soldering, direct welding, etc.), etc. The waveguide carrier 106 can include any rigid material (e.g., a metal, a composite, a glass, a plastic, etc.). In some such examples, the waveguide carrier 106 includes a transparent, translucent, and/or semi-transparent material. In the illustrated example of FIG. 1, the waveguide carrier 106 includes an example opening 124 between the wings 110A, 110B. In the illustrated example of FIG. 1, the body 108 includes an example first lateral surface 128 adjacent to the opening 124, the first wing 110A includes an example first tapered surface 132A adjacent to the opening 124, and the second wing 110B includes an example second tapered surface 132B adjacent to the opening 124.

The plates 112A, 112B facilitate the vertical alignment of the waveguide carrier 106 with the optical component carrier 116. In the illustrated example of FIG. 1, the plates 112A, 112B of the waveguide carrier 106 extend over the wings 110A, 110B, respectively. During the coupling of the waveguide carrier 106 and the optical component carrier 116, the plates 112A, 112B are positioned on an example top surface 133 of the optical component carrier 116. In some such examples, the abutment of the plates 112A, 112B and the top surface 133 of the optical component carrier 116 vertically aligns the waveguide array 114 and the component array 118.

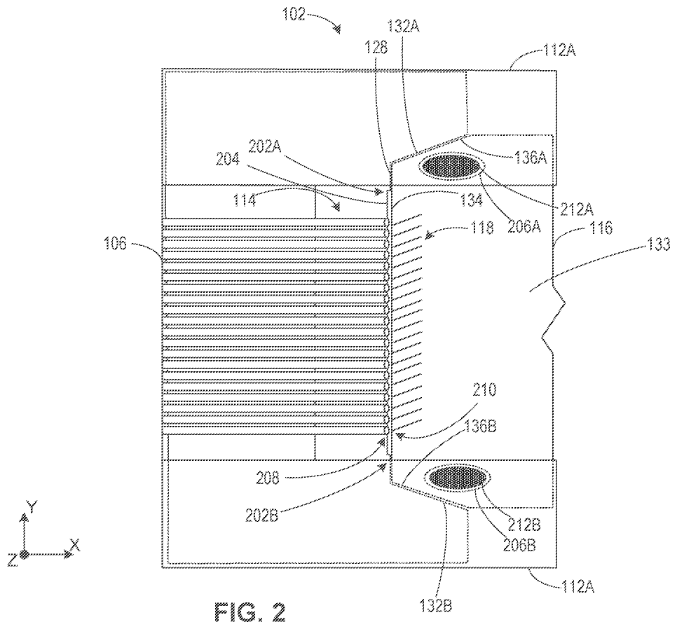

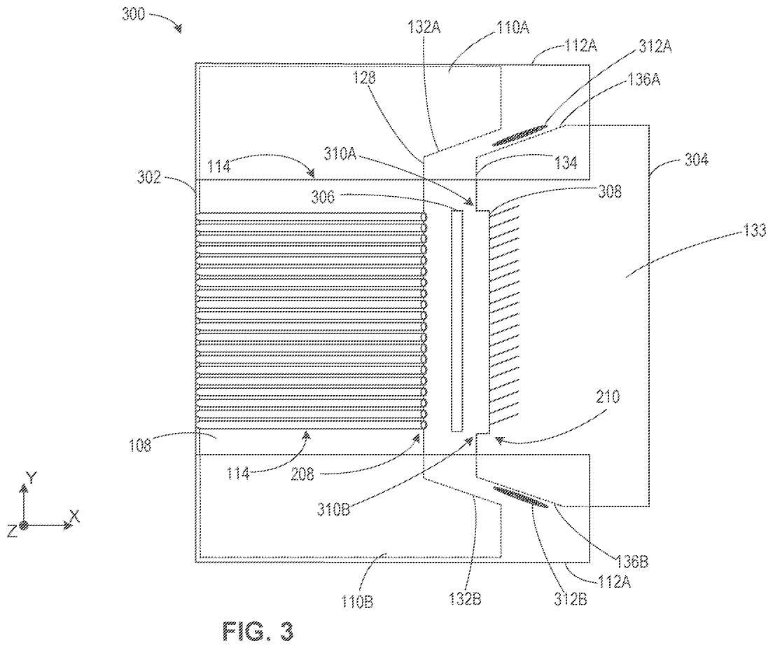

Additionally or alternatively, the plates 112A, 112B are coupled to the top surface 133 via one or more adhesives (e.g., photo-sensitive chemical adhesives, epoxies, etc.) to fixedly couple the waveguide carrier 106 to the optical component carrier 116. In some such examples, the plates 112A, 112B include a material that is permeable to ultra-violent light (e.g., a transparent, translucent, and/or semi-transparent material, etc.). For example, the plates 112A, 112B can include glass, reinforced glass, clear plastic, a transparent ceramic, a composite, and/or a combination thereof to facilitate the curing of photo-sensitive chemical adhesives or the like. Additionally or alternatively, the plates 112A, 112B may include any other suitable material (e.g., a metal, a ceramic, a composite, a plastic, etc.). An example coupling of the plates 112A, 112B and the optical component carrier 116 via a chemical adhesive is described below in conjunction with FIG. 2. An example coupling of the plates 112A, 112B and the optical component carrier 116 without a chemical adhesive is described below in conjunction with FIG. 3.

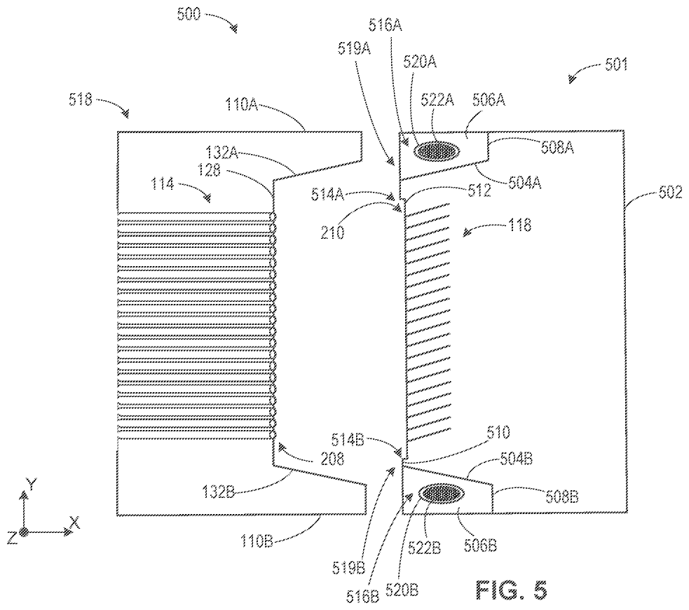

In the illustrated example of FIG. 1, the plates 112A, 112B are rectangular prisms. In other examples, the plates 112A, 112B can have any other suitable shapes (e.g., another prism, cylinders, etc.). In the illustrated example of FIG. 1, the waveguide carrier 106 includes two plates (e.g., the plates 112A, 112B, etc.), which extend over the wings 110A, 110B, respectively, and the tapered surfaces 132A, 132B, respectively. In other examples, the waveguide carrier 106 includes a single plate, which extends over the wings 110A, 110B and the opening 124. Additionally or alternatively, the plates 112A, 112B can be coupled to a bottom surface of the body 108 and/or the optical component carrier 116. In other examples, the plates 112A, 112B are absent. An example interconnect similar to the interconnect 102 without plates 112A, 112B is described below in conjunction with FIG. 5.

The waveguide array 114 extends through the body 108 of the waveguide carrier 106, such that the ends of the waveguide array 114 are substantially flush with the first lateral surface 128. In other examples, the waveguide array 114 is coupled to a bottom surface of the body 108, a middle of the body 108, and/or a top surface of the body 108. In some examples, the waveguides of the waveguide array 114 are integral with the body 108. For example, the waveguide array 114 can include one or more cylindrical portions (e.g., glass portions, plastic portions, etc.) that have different optical properties than the surrounding features of the body 108. In some such examples, the waveguide carrier 106 is manufactured via one or more additive manufacturing or planar waveguide circuit (PLC) process techniques. In other examples, the fibers of the ribbon 122 are inserted through cavities of the body 108, such that the ends of the fibers of the ribbon 122 are flush with the first lateral surface 128. In some examples, the first lateral surface 128 is polished to control the longitudinal position of the ends of the waveguide array 114.

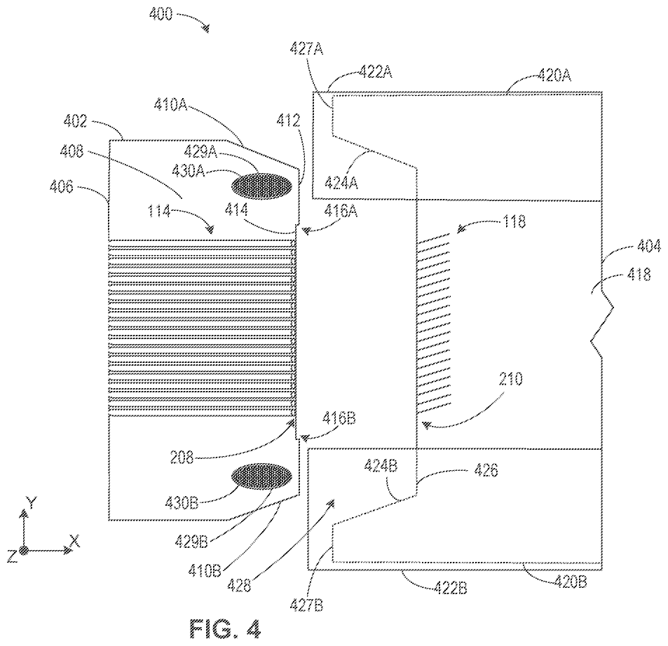

The optical component carrier 116 is a structure that includes (e.g., carries, contains, supports, etc.) the component array 118. In the illustrated example of FIG. 1, the optical component carrier 116 is a boss that extends from the PIC 104. In other examples, the optical component carrier 116 is on an example top surface 133 of the PIC 104 and/or in a cavity of the PIC 104. In the illustrated example of FIG. 1, the optical component carrier 116 includes an example second lateral surface 134, an example third tapered surface 136A, and an example fourth tapered surface 136B. In the illustrated example of FIG. 1, the optical component carrier 116 has a generally trapezoidal shape that is complementary with the opening 124 of the waveguide carrier 106 (e.g., the optical component carrier 116 fits within the opening 124, etc.). In other examples, the optical component carrier 116 includes an opening that receives a corresponding boss of the waveguide carrier 106. An example interconnect including an optical component carrier with an opening and a waveguide carrier with a boss is described below in conjunction with FIG. 4.

The component array 118 outputs and/or receives light signals (e.g., photons, light pulses, etc.) generated by the light signal generator/receiver 120 of the PIC 104. For example, the components of the component array 118 can output a corresponding light signal that for transmission a corresponding waveguide of the waveguide array 114 and a corresponding fiber of the ribbon 122. Additionally or alternatively, the components of the component array 118 can receive a corresponding light signal from a corresponding waveguide of the waveguide array 114. In some examples, the component(s) of the component array 118 are implemented via lasers, such as a diode laser, etc. In other examples, the component array 118 includes one or more other suitable light-emitting device(s) and/or light-receiving device(s).

In the illustrated example of FIG. 1, light signals received by the waveguide array 114 of the waveguide carrier 106 are transmitted to the ribbon 122. In some examples, the waveguides of the waveguide array 114 are coupled to the waveguides of the ribbon 122 via an index matching epoxy (IME), via a mechanical contact, via a sleeve, via a ferrule, etc. In other examples, the waveguides of the ribbon 122 are integral (e.g., continuous, etc.) with the waveguides of the waveguide array 114. In the illustrated example of FIG. 1, the ribbon 122 is an array of optical fibers. In other examples, the ribbon 122 includes one or more other types of optical waveguides (e.g., a dielectric waveguide, etc.).

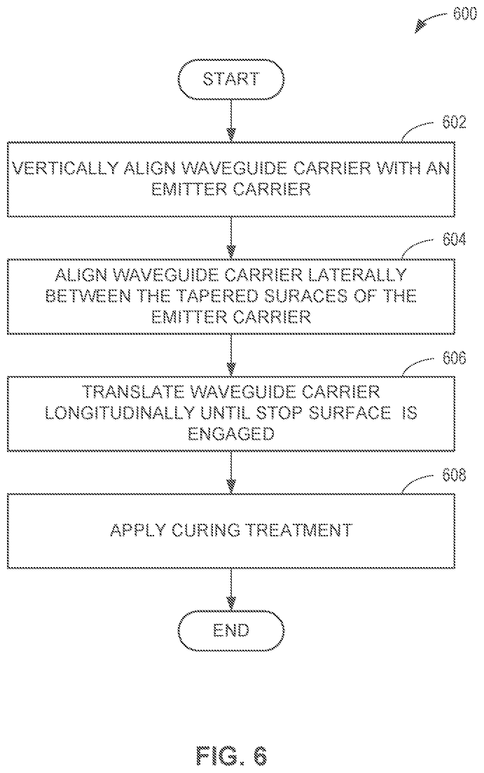

The interconnect 102 is created by the coupling of the waveguide carrier 106 and the optical component carrier 116 via engagement (e.g., abutment, contact, etc.) of (1) the first lateral surface 128 and the second lateral surface 134, (2) the first tapered surface 132A and the third tapered surface 136A, and (3) the second tapered surface 132B and the fourth tapered surface 136B. When establishing the interconnect 102, the opening 124 of the waveguide carrier 106 can be approximately laterally aligned with the optical component carrier 116 and the waveguide carrier 106 can be translated vertically until the plates 112A, 112B engage the top surface 133 of the optical component carrier 116. After the lateral and vertical alignment of the carriers 106, 116, the waveguide carrier 106 can be translated longitudinally toward the PIC 104 and/or vice versa. As the longitudinal displacement between waveguide carrier 106 between the optical component carrier 116 is reduced, one or both of the (1) the first tapered surface 132A will come into contact with the third tapered surface 136A, and/or (2) the second tapered surface 132B will contact the fourth tapered surface 136B. In some such examples, the abutment of the tapered surface 132A, 136A and/or the tapered surfaces 132B, 136B laterally moves and aligns the waveguide carrier 106 with the optical component carrier 116. In other words, the tapered surfaces 132A, 132B, 136A, 136B are cammed surfaces (e.g., cammed surfaces, cams, etc.) that function to align the carriers 106, 116. The longitudinal translation of the waveguide carrier 106 toward the optical component carrier 116 and/or vice versa can continue until the first lateral surface 128 abuts and/or is immediately adjacent to the second lateral surface 134 of the optical component carrier 116. The interconnect 102 between the waveguide carrier 106 and the optical component carrier 116 is described below in additional detail in conjunction with FIG. 2. Example operations to assemble the interconnect 102 are described below in conjunction with FIG. 6.

FIG. 2 is a top schematic view of the interconnect 102 of FIG. 1. In the illustrated example of FIG. 2, the first lateral surface 128 of the waveguide carrier 106 includes an example first detent 202A, an example second detent 202B, and an example inset surface 204. In the illustrated example of FIG. 2, the optical component carrier 116 includes an example first pocket 206A, and an example second pocket 206B. In the illustrated example of FIG. 2, the waveguide array 114 includes example waveguide ends 208 and the component array 118 includes example component ends 210. In the illustrated example of FIG. 2, the interconnect 102 includes 20 pairs of ones of the waveguide array 114 and the component array 118 (e.g., the waveguide array 114 includes 20 waveguides, the component array 118 includes 20 optical components respectively aligned with the waveguides, etc.). In other examples, the interconnect 102 includes any other suitable number of pairs of waveguides and optical components (e.g., two pairs, 12 pairs, 16 pairs, 32 pairs, 64 pairs, etc.). In the illustrated example of FIG. 2, the components of the component array 118 are angled relative to the longitudinal axis and the major axis of the waveguide carriers of the waveguide array 114. It should be appreciated that the angle of the components of the component array 118 may be exaggerated in the illustrated example of FIG. 2 and, in other examples, could be angled parallel to the longitudinal axis and/or refracted via the faceting of the waveguides of the waveguide carrier 106.

In the illustrated example of FIG. 2, the component ends 210 are flush with the second lateral surface 134. In the illustrated example of FIG. 2, the component array 118 (e.g., components of the component array 118, etc.) is between the third tapered surface 136A and the fourth tapered surface 136B. In the illustrated example of FIG. 2, the waveguide ends 208 are flush with the inset surface 204. In the illustrated example of FIG. 2, the waveguide array 114 (e.g., waveguides of the waveguide array, etc.) is between the first tapered surface 132A and the second tapered surface 132B. In the illustrated example of FIG. 2, the waveguide carrier 106 includes the inset surface 204, which is longitudinally inset (e.g., separated, etc.) from the first lateral surface 128 toward the body 108 of the waveguide carrier 106 via the detent 202A, 202B. In the illustrated example of FIG. 2, the detent 202A, 202B are in contact with (e.g., abutting, etc.) with the second lateral surface 134. The detent 202A, 202B prevent the abutment of the inset surface 204 and the second lateral surface 134, which reduces the likelihood of the component array 118 and/or the waveguide carrier 106 being damaged during the coupling of the waveguide carrier 106 and the optical component carrier 116 (e.g., reduces the likelihood of damage to the ends 208, 210 during assembly, etc.).

The abutment of the detent 202A, 202B and the second lateral surface 134 enables an operator (e.g., a human, mechanical, and/or robotic assembler, etc.) assembling the interconnect 102 to identify when the waveguide ends 208 and the component ends 210 are longitudinally aligned. The abutment of the first tapered surface 132A and the third tapered surface 136A and the abutment of the second tapered surface 132B and the fourth tapered surface 136B enables the operator to identify the lateral alignment of the waveguide ends 208 and the component ends 210. The abutment of the plates 112A, 112B and the top surface 133 enables an operator to identify when the ends 208 of the waveguide carrier 106 and the ends 210 of optical component carrier 116 are vertically aligned. Accordingly, the human, mechanical and/or robotic assembler of the interconnect 102 can identify that the waveguide carrier 106 and the optical component carrier 116 are aligned based on the contact between (1) the tapered surfaces 132A, 132B, 136A, 136B, (2) the plates 112A, 112B and the top surface 133, and (3) the second lateral surface 134 and the detent 202A, 202B of the first lateral surface 128. That is, the relative translation of the waveguide carrier 106 and the optical component carrier 116 along the tapered surfaces 132A, 132B, 136A, 136B enables the self-alignment of the waveguide ends 208 and the component ends 210. As such, the tapered surfaces 132A, 132B, 136A, 136B and the plates 112A, 112B facilitate the comparatively faster assembly of the interconnect 102 when compared to prior optical interconnects.

Because the ends of the waveguide array 114 are flush with the inset surface 204 and the component array 118 is flush with the second later surface 134, the longitudinal length of the detent 202A, 202B (e.g., the longitudinal distance between the first lateral surface 128 and the inset surface 204, etc.) controls the longitudinal distance between the waveguide ends 208 and the component ends 210. For example, the detent 202A, 202B can be between 2 and 20 microns long. In other examples, the detent 202A, 202B can have any other suitable length. For example, the size of the detent 202A, 202B can be greater (e.g., 200 microns, 300 microns, 500 microns, depending on a length of an isolator, etc.) to facilitate the coupling of an isolator (e.g., a free space isolator, etc.) between the waveguide ends 208 and the component ends 210. An example interface including an isolator is described below in conjunction with FIG. 3.

In the illustrated example of FIG. 2, the pockets 206A, 206B are cavities (e.g., blind holes, etc.) in the top surface 133 of the optical component carrier 116. In the illustrated example of FIG. 2, an example first adhesive 212A is in the first pocket 206A and an example second adhesive 212B is in the second pocket 206B. Prior to the alignment of the waveguide carrier 106 and the optical component carrier 116 via gliding along the tapered surfaces 132A, 132B, 136A, 136B, the adhesives 212A, 212B (e.g., a photo-sensitive adhesive, etc.) are disposed in the pockets 206A, 206B. In some examples, if the adhesives 212A, 212B are photo-sensitive, after alignment of the waveguide carrier 106 and the optical component carrier 116, ultraviolet (UV) light can be applied to the interconnect 102 and through the plates 112A, 112B, to cause the adhesives 212A, 212B to flow and bond the plates 112A, 112B to the optical component carrier 116. In other examples, the adhesives 212A, 212B can be implemented by one or more heat-curing adhesive(s) and/or moisture-curing adhesive(s). In the illustrated example of FIG. 2, the pockets 206A, 206B and the adhesives 212A, 212B are distal to the ends 208, 210. Accordingly, the placement of the adhesives 212A, 212B decreases the likelihood of adhesive flowing between the ends 208, 210.

FIG. 3 is a partially exploded top schematic view of another example interconnect 300. The interconnect 300 can be used in conjunction with the system 100 of FIG. 1. In the illustrated example of FIG. 3, the interconnect 300 includes an example waveguide carrier 302 and an example optical component carrier 304, which are similar to the waveguide carrier 106 of FIGS. 1 and 2 and the optical component carrier 304 of FIGS. 1 and 2, respectively, except as noted otherwise. In the illustrated example of FIG. 3, the interconnect 300 includes an example isolator assembly 306. In the illustrated example of FIG. 3, the waveguide carrier 302 includes the body 108 of FIGS. 1 and 2, the waveguide array 114 of FIGS. 1 and 2, the example wings 110A, 110B of FIGS. 1 and 2, the plates 112A, 112B of FIGS. 1 and 2, the first lateral surface 128, and the example tapered surfaces 132A, 132B. In the illustrated example of FIG. 3, the optical component carrier 304 includes the second lateral surface 134 of FIGS. 1 and 2, the tapered surfaces 136A, 136B of FIGS. 1 and 2, an example inset surface 308, an example first detent 310A, and an example second detent 310B. In the illustrated example of FIG. 3, an example first adhesive 312A and an example second adhesive 312B are disposed between (1) the first tapered surface 132A and the third tapered surface 136A and (2) the second tapered surface 132B and the fourth tapered surface 136B, respectively.

In the illustrated example of FIG. 3, the waveguide ends 208 are flush with the second lateral surface 134. In the illustrated example of FIG. 3, the component ends 210 are flush with the inset surface 308. Like the detent 202A, 202B of FIG. 2, the detents 310A, 310B of FIG. 3 enable the longitudinal alignment of the waveguide ends 208 and the component ends 210. That is, when the interconnect 300 is assembled, the detents 310A, 310B abut (e.g., contact, etc.) the first lateral surface 128. As such, an assembler of the interconnect 300 can determine the component ends 210 and the waveguide ends 208 are longitudinally aligned based on an abutment of the first lateral surface 128 and the detents 310A, 310B of the second lateral surface 134. In some examples, the interconnect 300 can be laterally and vertically aligned in a manner similar to the interconnect 102 of FIGS. 1 and 2 (e.g., via the abutment of the plates 112A, 112B and the top surface 133 of the optical component carrier 304, via the abutment of the tapered surfaces 132A, 132B, 136A, 136B, etc.). In some examples, the detents 310A, 310B prevent the abutment of the inset surface 308 and the first lateral surface 128, which reduces the likelihood of the component array 118 and/or the waveguide carrier 106 being damaged during the assembly of the interconnect 300.

In the illustrated example of FIG. 3, the displacement of the inset surface 308 from the second lateral surface 134 (e.g., the longitudinal lengths of the detents 310A, 310B, etc.) is comparatively greater than the displacement of the inset surface 204 from the first lateral surface 128 of the interconnect of FIG. 2 (e.g., the longitudinal lengths of the detent 202A, 202B of FIG. 2, etc.). In the illustrated example of FIG. 3, the displacement between the inset surface 308 and the second lateral surface 134 enables the positioning of the isolator assembly 306 between the component ends 210 and the waveguide ends 208. For example, the isolator assembly 306 can include one or more discrete free space isolator(s), one or more lens, one or more light converter(s), and/or one or more optical diode(s). In some examples, some lateral portions of the isolator assembly 306 do not include such components (e.g., portions associated with light-receiving ones of the component array 118, portions associated with light-generating ones of the component array 118, etc.). In some examples, the isolator assembly 306 prevents the backflow of light signals (e.g., optical feedback, etc.) from the waveguide array 114 to the optical component carrier 304. Accordingly, the interconnect 300 of FIG. 3 reduces the need for external fiber in-line isolators when compared to prior isolators, which reduces overall system cost and complexity. In some examples, the isolator assembly 306 is absent. In some such examples, the detents 310A, 310B have a longitudinal length similar to the length of the detents 202A, 202B of FIG. 2.

The adhesives 312A, 312B of FIG. 3 fixedly couple the waveguide carrier 302 to the optical component carrier 304. In the illustrated example of FIG. 3, the first adhesive 312A is between the first tapered surface 132A and the third tapered surface 136A and the second adhesive 312B is disposed between the second tapered surface 132B and the fourth tapered surface 136B. In some examples, some or all of the tapered surfaces 132A, 136A and/or the tapered surfaces 132B, 136B include a pocket (e.g., a cavity, a blind hole, etc.) that includes the adhesives 312A, 312B prior to the alignment of the waveguide ends 208 and the component ends 210. In some examples, the adhesives 312A, 312B are photo-curing adhesives. In some such examples, the body 108 of the waveguide carrier 302 includes a material permeable to ultra-violet light (e.g., a transparent, translucent, and/or otherwise photo-permeable material, etc.). For example, the body 108 can be composed of a glass, a transparent composite, a plastic, and/or a combination thereof, to facilitate the exposure of the adhesives 312A, 312B to ultraviolet light. In other examples, the adhesives 312A, 312B are heat and/or moisture-curing adhesives. In the illustrated example of FIG. 3, the adhesives 312A, 312B are distal to the ends 208, 210. Accordingly, the placement of the adhesives 312A, 312B in the interconnect 300 decreases the likelihood of adhesive becoming disposed between the ends 208, 210.

FIG. 4 is a partially exploded top schematic view of another example interconnect 400 including an example waveguide carrier 402 and an example optical component carrier 404, which are similar to the waveguide carrier 106 of FIGS. 1 and 2 and the optical component carrier 116 of FIGS. 1 and 2, respectively, except as noted otherwise. The interconnect 400 can be used in conjunction with the system 100 of FIG. 1. In the illustrated example of FIG. 4, the waveguide carrier 402 includes an example body 406, an example top surface 408, the waveguide array 114 of FIGS. 1 and 2, an example first tapered surface 410A, an example second tapered surface 410B, an example first lateral surface 412, an example inset surface 414, an example first detent 416A, and an example second detent 416B. In the illustrated example of FIG. 4, the optical component carrier 404 includes the component array 118, an example body 418, an example first wing 420A, an example second wing 420B, an example first plate 422A, an example second plate 422B, an example third tapered surface 424A, an example fourth tapered surface 424B, and an example second lateral surface 426. In the illustrated example of FIG. 4, the wings 420A, 420B define an example opening 428 therebetween.

The interconnect 400 is created by the coupling of the waveguide carrier 402 and the optical component carrier 404 and permits the transmission of light signals from the component array 118 to the waveguide array 114. The interconnect 400 is similar to the interconnect 102 of FIGS. 1 and 2 and the interconnect 300 of FIG. 3, except that the body 406 of the waveguide carrier 402 is received by the opening 428 of the optical component carrier 404 (e.g., the waveguide carrier 402 is disposed within the optical component carrier 404, etc.). The interconnect 400 is created via the abutment of (1) the first lateral surface 412 and the second lateral surface 426, (2) the first tapered surface 410A and the third tapered surface 424A, and (3) the second tapered surface 410B and the fourth tapered surface 424B.

In the illustrated example of FIG. 4, the body 406 of the waveguide carrier 402 is generally trapezoidal shaped. In the illustrated example of FIG. 4, the waveguide carrier 402 includes the inset surface 414, which is longitudinally displaced from the first lateral surface 412 via the detents 416A, 416B. The inset surface 414 is similar to the inset surface 204 of FIG. 2 and prevents the direct abutment of the waveguide ends 208 and the component ends 210. Similarly to the detent 202A, 202B of FIG. 2, the engagement (e.g., abutment, etc.) of the detents 416A, 416B and the second lateral surface 426 can be used to longitudinally align the ends 208, 210 In other examples, the inset surface 414 and the detents 416A, 416B are absent. In some such examples, the second lateral surface 426 includes an inset surface and/or detents (e.g., similar to the inset surface 308 and/or the detents 310A, 310B of FIG. 3, etc.).

In the illustrated example of FIG. 4, the optical component carrier 404 is shaped to receive the body 406 of the waveguide carrier 402. That is, the wings 420A, 420B of the optical component carrier 404 are shaped such that the opening 428 is complimentary with the body 406. In the illustrated example of FIG. 4, the body 418 of the optical component carrier 404, the wings 420A, 420B are integral and the plates 422A, 422B are discrete components coupled thereto. In other examples, the body 418, the wings 420A, 420B, and the plates 422A, 422B are integral (e.g., manufactured from a singular blank, additively manufactured, etc.). In other examples, the components of the optical component carrier 404 are coupled via one or more chemical adhesive(s), one or more interference fit(s), one or more laser weld(s), etc. The optical component carrier 404 can be composed of any rigid material (e.g., a metal, a composite, a glass, a plastic, etc.). In some such examples, the waveguide carrier 106 is composed of a transparent, translucent, and/or semi-transparent material.

In some examples, the optical component carrier 404 is disposed on an edge of a PIC (e.g., similar to the optical component carrier 116 of FIG. 1, etc.). In some such examples, example tips 427A, 427B of the wings are engaged with the edge of the PIC. In other examples, the optical component carrier 404 is disposed on a top or bottom surface of a PIC. The plates 422A, 422B are similar to the plates 112A, 112B, except that the plates 422A, 422B extend over the wings 420A, 420B of the optical component carrier 404. The plates 422A, 422B facilitate the vertical alignment of the ends 208, 210 and extend over the wings 420A, 420B, respectively.

To create the interconnect 400, the opening 428 can be approximately laterally aligned with the body 406 of the waveguide carrier 402 and the waveguide carrier 402 can be translated vertically until the top surface 408 abuts the plates 422A, 422B of the optical component carrier 404. After the longitudinal and vertical alignment, the waveguide carrier 402 can be translated longitudinally towards the component array 118. As the waveguide carrier 402 is longitudinally displaced toward the optical component carrier 404, (1) the first tapered surface 410A will engage (e.g., come into contact with, etc.) the third tapered surface 424A, and/or (2) the second tapered surface 410B will engage (e.g., come into contact with, etc.) the fourth tapered surface 424B. In some such examples, the engagement of the tapered surfaces 410A, 410B and/or the tapered surfaces 424B, 424B laterally moves the waveguide carrier 402 relative to optical component carrier 404 and aligns the ends 208, 210. The longitudinal translation of the waveguide carrier 106 toward the optical component carrier 116 can continue until the first lateral surface 412 abuts and/or is immediately adjacent to the second lateral surface 426.

In the illustrated example of FIG. 4, the top surface 408 of the waveguide carrier 402 includes an example first pocket 429A and an example second pocket 429B, which include an example first adhesive 430A and an example second adhesive 430B disposed therein, respectively. The pockets 429A, 429B and the adhesives 430A, 430B are similar to the pockets 206A, 206B and the adhesive 212A, 212B of FIG. 2, respectively. Like the adhesives 212A, 212B of FIG. 2, the adhesives 430A, 430B are distal to the ends 208, 210 and can be cured to couple the top surface 408 of the waveguide carrier 106 to the plates 422A, 422B. Additionally or alternatively, the waveguide carrier 402 and the optical component carrier 404 are coupled via one or more adhesive(s) (1) disposed between the first tapered surface 410A and the third tapered surface 424A and/or (2) disposed between the second tapered surface 410B and the fourth tapered surface 424B. In some such examples, the pockets 429A, 429B, the adhesives 430A, 430B, and/or the plates 422A, 422B are absent. Additionally or alternatively, the waveguide carrier 402 and the optical component carrier 404 are coupled via one or more fasteners, via one or more additional chemical adhesive(s), via one or more weld(s), one or more interference fit(s).

FIG. 5 is a top schematic view of another interconnect 500 including an example optical component carrier 501. In the illustrated example of FIG. 5, the optical component carrier 501 includes the component array 118 of FIGS. 1-4. an example body 502, an example first tapered surface 504A, an example second tapered surface 504B, an example first receiving surface 506A, an example second receiving surface 506B, an example first stop surface 508A, an example second stop surface 508B, and an example lateral surface 510. In the illustrated example of FIG. 1, the optical component carrier 501 includes an example inset surface 512, an example first detent 514A, and an example second detent 514B, which are similar to the inset surface 308 of FIG. 3, the first detent 310A of FIG. 3, and the second detent 310B of FIG. 3, except as noted otherwise. In the illustrated example of FIG. 5, the first tapered surface 504A, the first receiving surface 506A, and the first stop surface 508A define an example first opening 516A. In the illustrated example of FIG. 5, the second tapered surface 504B, the second receiving surface 506B, and the second stop surface 508B define an example second opening 516B.

In the illustrated example of FIG. 5, the interconnect 500 includes an example waveguide carrier 518, which is similar to the waveguide carrier 106 of FIGS. 1 and 2, except that the waveguide carrier 518 does not include the plates 112A, 112B. In the illustrated example of FIG. 5, the waveguide carrier 518 includes the waveguide array 114 of FIGS. 1 and 2, the first lateral surface 128, the example wings 110A, 110B of FIGS. 1 and 2, the tapered surfaces 132A, 132B of FIGS. 1 and 2, and the waveguide ends 208 of FIG. 2.

The openings 516A, 516B can receive (e.g., engage with, etc.) the wings 110A, 110B of the waveguide carrier 518. That is, the tapered surfaces 504A, 504B are to engage with corresponding and complimentary tapered surfaces of the waveguide carrier 518 (e.g., the tapered surfaces 132A, 132B, etc.) and the receiving surfaces 506A, 506B are to engage with a bottom surface of the wings 110A, 110B of the waveguide carrier 518. In the illustrated example of FIG. 5, the first opening 516A is disposed on an example first side 519A of the lateral surface 510 and the second opening 516B is disposed on an example second side 519B of the lateral surface 510. In the illustrated example of FIG. 5, the first side 519A is opposite to the second side 519B of the lateral surface 510 and the component array 118 relative to the lateral axis. The engagement (e.g., contact, abutment, etc.) of the first tapered surface 504A and the first tapered surface 132A of the waveguide carrier 518 and the engagement (e.g., contact, abutment, etc.) of the second tapered surface 504B and the second tapered surface 132B of the waveguide carrier 518 enables an operator to laterally align the waveguide ends 208 and the component ends 210.

Like the inset surface 308 and the detents 310A, 310B of FIG. 3, the inset surface 512 and the detents 514A, 514B facilitate the longitudinal alignment of the optical component carrier 501 and the waveguide carrier 518. In some examples, the detents 514A, 514B prevent the component ends 210 from abutting the waveguide ends 208. In the illustrated example of FIG. 5, the stop surfaces 508A, 508B can also be used for the longitudinal alignment of the component ends 210. For example, the relative longitudinal alignment of the optical component carrier 116 and the waveguide carrier 518 can be determined based on the abutment of the wings 110A, 110B and the stop surfaces 506A, 506B. Additionally or alternatively, the receiving surfaces 506A, 506B can include one or more etches that engage with a corresponding feature of a waveguide carrier to longitudinally align the optical component carrier and a corresponding feature of the wings 110A, 110B. In some examples, the stop surfaces 508A, 508B are absent. In some such examples, the longitudinal translation of the wings 110A, 110B within the openings 516A, 516B is inhibited by the engagement (e.g., the abutment, contact of, etc.) of the lateral surface 510 and the first lateral surface 128 of the waveguide carrier 518.

In the illustrated example of FIG. 5, the receiving surfaces 506A, 506B include an example first pocket 520A and an example second pocket 520B, respectively. In the illustrated example of FIG. 5, an example first adhesive 522A is in the first pocket 520A and an example second adhesive 522B is in the second pocket 520B. In some examples, the adhesives 522A, 522B couple the optical component carrier 501 to the waveguide carrier 518. In some examples, the adhesives 522A, 522B are ultraviolet curing adhesives that can be cured via the application of ultraviolet light after the aligning of the optical component carrier 501 and a corresponding waveguide carrier (e.g., the waveguide carrier 106 of FIGS. 1-3, etc.). In other examples, the adhesives 522A, 522B are moisture-cured adhesives and/or heat-cured adhesives. In the illustrated example of FIG. 5, the pockets 520A, 520B and the adhesives 522A, 522B are distal to the component ends 210. Accordingly, the placement of the adhesives 522A, 522B in FIG. 5 decreases the likelihood of adhesive becoming disposed between the component ends 210 and the waveguide ends 208.

Additionally or alternatively, some or all of the stop surfaces 508A, 508B and/or the tapered surfaces 132A, 132B, 504A, 504B include pockets and adhesives similar to the pockets 520A, 520B and adhesives 522A, 522B. In some such examples, the pockets 520A, 520B and/or the adhesives 522A, 522B are absent. In other examples, the waveguide carrier 518 and the optical component carrier 501 are coupled via one or more fasteners, one or more welds, one or more interface fits, and/or one or more other chemical adhesive(s). In some examples, the adhesives 522A, 522B can include solder, which can be cured via laser welding and/or the application of heat. FIG. 6 is a flowchart representative of example operations 600 that can be used to assemble an optical interconnect implemented in accordance with the teachings of this disclosure. The example operations 600 are described with reference to the interconnect 102 of FIG. 1. However, it should be appreciated the operations 600 can be used to assemble other interfaces disclosed herein. For example, the operations 600 can be used to assemble the interconnect 300 of FIG. 3, the interconnect 400 of FIG. 4, and/or an interconnect 500 of FIG. 5.

The operations 600 begin at block 602, at which the waveguide carrier 106 is vertically aligned with the optical component carrier 116. For example, the waveguide carrier 106 can be positioned and vertically translated until the plates 112A, 112B engage with the top surface 133 of the optical component carrier 116. Additionally or alternatively, the waveguide carrier 106 can be aligned with another vertical feature of the optical component carrier 116 (e.g., the receiving surfaces 506A, 506B of FIG. 5, the plates 422A, 422B of FIG. 4, etc.). At block 604, the waveguide carrier 106 is laterally aligned between the tapered surfaces 136A, 136B of the optical component carrier 116. For example, the waveguide carrier 106 can be translated laterally until the waveguide carrier 106 is approximately centered between the tapered surfaces 136A, 136B (e.g., laterally aligned such that body 108 is aligned with the opening 124, etc.). At block 606, the waveguide carrier 106 is translated longitudinally until a stop surface is engaged. For example, the waveguide carrier 106 can be translated longitudinally until the first lateral surface 128 of the waveguide carrier 106 engages (e.g., comes into contact with, etc.) the second lateral surface 134 of the optical component carrier 116. At block 608, the adhesives 212A, 212B are cured. For example, ultraviolet light can be applied to the interconnect 102 to cause the adhesives 212A, 212B to cure (e.g., flow and set, etc.) and fixedly couple the waveguide carrier 106 to the optical component carrier 116. In other examples, the adhesives 212A, 212B can be cured via the application of heat and/or water. Additionally or alternatively, the waveguide carrier 106 and the optical component carrier 116 can be coupled in any other suitable manner (e.g., via soldering, via welding, via one or more fasteners, etc.).

Although the example operations 600 are described with reference to the flowchart illustrated in FIG. 6, many other methods of assembling an interconnect implemented in accordance with the teachings of this disclosure may alternatively be used. For example, the order of execution of the blocks may be changed, and/or some of the blocks described may be changed, eliminated, or combined.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that objects. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

Optical interconnects and related methods are disclosed herein. Further examples and combinations thereof include the following:

Example 1 includes an apparatus comprising an optical component carrier including a first tapered surface, a second tapered surface, and an optical component, a waveguide carrier including a third tapered surface engaged with the first tapered surface, and a fourth tapered surface engaged with the second tapered surface, and a waveguide including a second end aligned with the first end.

Example 2 includes the apparatus of any preceding example, wherein the optical component carrier further includes a lateral surface, and an inset surface parallel to and spaced from the lateral surface, the first end substantially flush with the inset surface.

Example 3 includes the apparatus of any preceding example, wherein the lateral surface is a first lateral surface and the waveguide carrier further includes a second lateral surface engaged with the first lateral surface, the second end substantially flush with the second lateral surface.

Example 4 includes the apparatus of any preceding example, wherein the waveguide carrier further includes a wing extending from the waveguide carrier, the wing including the second tapered surface.

Example 5 includes the apparatus of any preceding example, wherein the waveguide carrier further includes a plate over the wing, the plate coupled to the optical component carrier via an adhesive.

Example 6 includes the apparatus of any preceding example, wherein the optical component carrier includes a pocket, the pocket including the adhesive.

Example 7 includes the apparatus of any preceding example, wherein the wing is a first wing, the waveguide carrier further includes a second wing, the optical component carrier between the first wing and the second wing.

Example 8 includes the apparatus of any preceding example, further including an adhesive on at least one of the first tapered surface or the third tapered surface.

Example 9 includes the apparatus of any preceding example, wherein the waveguide carrier includes a material that is permeable to ultra-violet light.

Example 10 includes the apparatus of any preceding example, further including an isolator between the first end and the second end.

Example 11 includes the apparatus of any preceding example, wherein the optical component is between the first tapered surface and the second tapered surface.

Example 12 includes a waveguide carrier including a first tapered surface, a second tapered surface, a body including a lateral surface between the first tapered surface and the second tapered surface, and a waveguide.

Example 13 includes the waveguide carrier of any preceding example, further including a first wing extending from the body, the first wing including the first tapered surface, and a second wing extending from the body, the second wing including the second tapered surface.

Example 14 includes the waveguide carrier of any preceding example, further including a plate over the first wing.

Example 15 includes the waveguide carrier of any preceding example, wherein the body includes an inset surface separated from the lateral surface along an axis parallel to a major axis of the waveguide.

Example 16 includes the waveguide carrier of any preceding example, further including a pocket on at least one of a top surface of the body, the first tapered surface, or the second tapered surface.

Example 17 includes the waveguide carrier of any preceding example, wherein the waveguide includes an end flush with the lateral surface.

Example 18 includes an optical component carrier comprising a first tapered surface, a second tapered surface, a body including a lateral surface between the first tapered surface and the second tapered surface, and an optical component.

Example 19 includes the optical component carrier of any preceding example, wherein the body further includes a first opening adjacent to a first side of the lateral surface, the first tapered surface continuous with the lateral surface and extending into the first opening, and a second opening adjacent to a second side of the lateral surface, the second tapered surface continuous with the lateral surface and extending into the second opening.

Example 20 includes the optical component carrier of any preceding example, wherein the body further includes a pocket including an adhesive.

Example 21 includes the optical component carrier of any preceding example, further including a first wing including the first tapered surface, and a second wing including the second tapered surface.

Example 22 includes the optical component carrier of any preceding example, further including a plate over the first wing.

Example 23 includes the optical component carrier of any preceding example, wherein the optical component includes an end flush with the lateral surface.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
an optical component carrier including:
a first tapered surface;
a second tapered surface; and
an optical component;
a waveguide carrier including:
a third tapered surface engaged with the first tapered surface; and
a fourth tapered surface engaged with the second tapered surface; and
a waveguide including a second end aligned with the first end.

2. The apparatus of claim 1, wherein the optical component carrier further includes:
a lateral surface; and
an inset surface parallel to and spaced from the lateral surface, the first end substantially flush with the inset surface.

3. The apparatus of claim 2, wherein the lateral surface is a first lateral surface and the waveguide carrier further includes a second lateral surface engaged with the first lateral surface, the second end substantially flush with the second lateral surface.

4. The apparatus of claim 1, wherein the waveguide carrier further includes a wing extending from the waveguide carrier, the wing including the second tapered surface.

5. The apparatus of claim 4, wherein the waveguide carrier further includes a plate over the wing, the plate coupled to the optical component carrier via an adhesive.

6. The apparatus of claim 5, wherein the optical component carrier includes a pocket, the pocket including the adhesive.

7. The apparatus of claim 4, wherein the wing is a first wing, the waveguide carrier further includes a second wing, the optical component carrier between the first wing and the second wing.

8. The apparatus of claim 1, further including an adhesive on at least one of the first tapered surface or the third tapered surface.

9. The apparatus of claim 1, further including an isolator between the first end and the second end.

10. The apparatus of claim 1, wherein the optical component is between the first tapered surface and the second tapered surface.

11. A waveguide carrier including:
a first tapered surface;
a second tapered surface;
a body including a lateral surface between the first tapered surface and the second tapered surface; and
a waveguide.

12. The waveguide carrier of claim 11, further including:
a first wing extending from the body, the first wing including the first tapered surface; and
a second wing extending from the body, the second wing including the second tapered surface.

13. The waveguide carrier of claim 12, further including a plate over the first wing.

14. The waveguide carrier of claim 11, wherein the body includes an inset surface separated from the lateral surface along an axis parallel to a major axis of the waveguide.

15. The waveguide carrier of claim 11, further including a pocket on at least one of a top surface of the body, the first tapered surface, or the second tapered surface.

16. The waveguide carrier of claim 11, wherein the waveguide includes an end flush with the lateral surface.

17. An optical component carrier comprising:
a first tapered surface;
a second tapered surface;
a body including a lateral surface between the first tapered surface and the second tapered surface; and
an optical component.

18. The optical component carrier of claim 17, wherein the body further includes:
a first opening adjacent to a first side of the lateral surface, the first tapered surface continuous with the lateral surface and extending into the first opening; and
a second opening adjacent to a second side of the lateral surface, the second tapered surface continuous with the lateral surface and extending into the second opening.

19. The optical component carrier of claim 17, further including:
a first wing including the first tapered surface;
a second wing including the second tapered surface; and
a plate over the first wing.

20. The optical component carrier of claim 17, wherein the optical component includes an end flush with the lateral surface.
